(19) United States
(12) Patent Application Publication
(10) Pub. No.: US 2020/0242690 A1
(43) Pub. Date: Jul. 30, 2020

(54) DIGITAL COMMODITY EXCHANGE SYSTEM AND METHOD

(71) Applicant: Shenzhen Fugui Precision Ind. Co., Ltd., Shenzhen (CN)

(72) Inventor: SHIH-CHENG WANG, New Taipei (TW)

(21) Appl. No.: 16/296,351

(22) Filed: Mar. 8, 2019

(30) Foreign Application Priority Data
Jan. 30, 2019 (CN) 201910093658.4

(51) Int. Cl. G06Q 40/04; H04L 9/06; G06Q 20/06; G06Q 20/40; G06Q 20/38

(52) U.S. Cl. CPC G06Q 40/04; H04L 9/0637; G06Q 20/3825; G06Q 20/405; G06Q 20/0658

(57) ABSTRACT

A digital commodity exchange method is implemented in an electronic device. The method includes receiving a digital commodity and exchanging conditions of the digital commodity, generating a first exchange contract of the digital commodity, storing the first exchange contract to a blockchain platform of the electronic device and broadcasting the first exchange contract on each node of the blockchain, searching a number of exchange contracts in the electronic device and identifying a second exchange contract that matches the exchange information in the first exchange contract, storing the first exchange contract and the second exchange contract in the form of a message queue in the electronic device, and transmitting the digital commodity of the first exchange contract and the digital commodity of the second exchange contract to the terminal device of the second exchange contract and the terminal device of the first exchange contract, respectively.

### FIELD

The subject matter herein generally relates to transaction methods, and more particularly to a digital commodity exchange system and method implemented in an electronic device.

### BACKGROUND

With the development of big data analysis and network communication technology, the interaction of digital information has become more and more frequent. For example, in the transaction of virtual currency or commodities, there is a large amount of information transmission, access, and exchange. Existing transaction methods are prone to information leakage or false information, and the information exchange efficiency is not high, resulting in reduced transaction efficiency, potential security breaches, and inconvenience to users.

### BRIEF DESCRIPTION OF THE DRAWINGS

Implementations of the present disclosure will now be described, by way of embodiments, with reference to the attached figures.

FIG. 1 is a schematic diagram of an embodiment of an application environment of a digital commodity exchange method.

FIG. 2 is a flowchart of an embodiment of a commodity exchange method.

FIG. 3 is a structural diagram of an embodiment of a commodity exchange system.

FIG. 4 is a schematic diagram of an embodiment of an electronic device.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

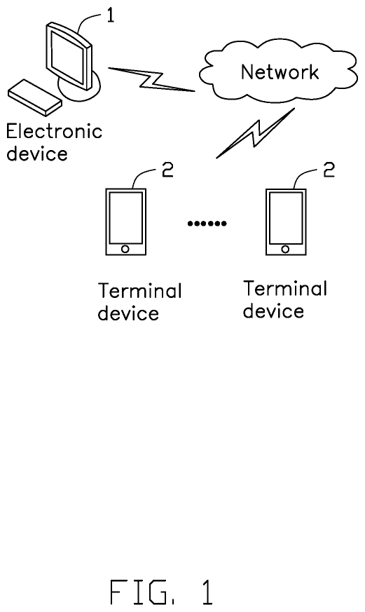

FIG. 1 is a schematic diagram of an application environment of a digital commodity exchange method.

The digital commodity exchange method is applied in an electronic device 1 that establishes communication with at least one terminal device 2 via a network. The network may be a wired network or a wireless network, such as radio, Wireless Fidelity (WIFI), cellular, satellite, broadcast, and the like.

The electronic device 1 may be a personal computer, a server, or the like installed with a commodity exchange program. The server may be a single server, a server cluster, a cloud server, or the like.

The terminal device 2 may be a smart phone, a tablet computer, a laptop computer, a desktop computer, or the like.

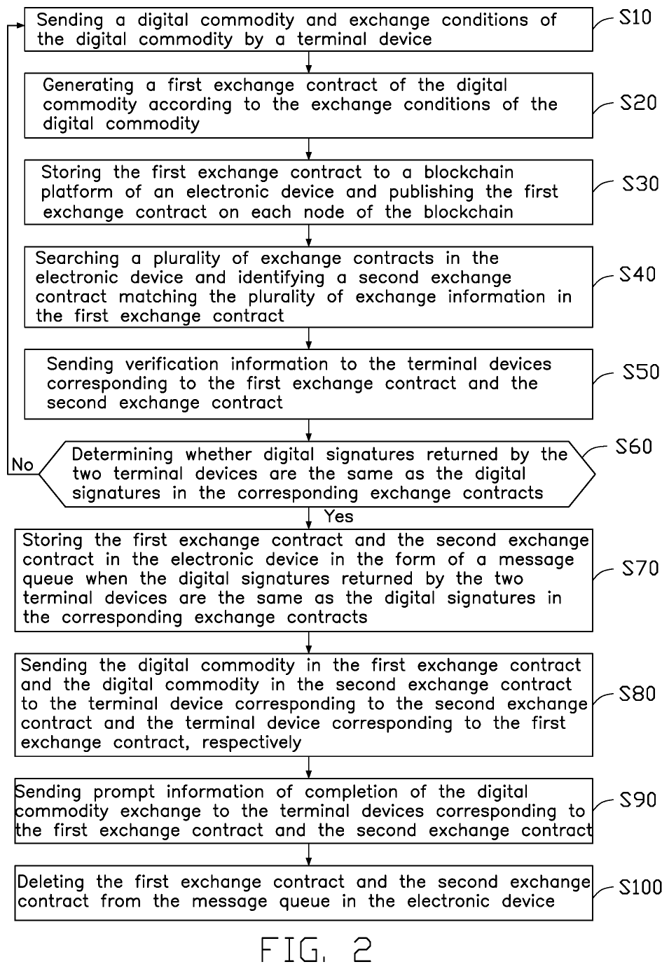

FIG. 2 shows a flowchart of an embodiment of a commodity exchange method. The order of the blocks in the flowchart may be changed according to different requirements, and some blocks may be omitted.

At block S10, digital commodities and exchange conditions of the digital commodities are sent by a user terminal device 2.

In one embodiment, the user terminal device 2 is equipped with commodity exchange software, and a user can log into the commodity exchange system with an account number and password. The commodity exchange software provides a commodity exchange interface, and the user can input a digital commodity to be exchanged and an exchanging condition of the digital commodity in the commodity exchange interface. The digital commodity to be exchanged and a plurality of exchange conditions of the digital commodity are input and uploaded to the commodity exchange system such that the electronic device 1 receives the digital commodity and the plurality of exchange conditions of the digital commodity transmitted from the terminal device 2.

In one embodiment, the digital commodity is a digital file, such as a movie, a picture, a voice clip, an analysis chart, a statistical report, or the like, and may be produced from a physical item or operation, such as from a picture taken of a physical coupon or redemption voucher, or such as from a movie formed by a process of combining a plurality of images.

In one embodiment, the exchange conditions include, but are not limited to, an exchange form, an exchange method, an exchange target item, an exchange area, and a validity period of the exchange target item. The exchange form includes at least an auction, a lease, and an exchange. The exchange method includes at least a one-to-one exchange, a many-to-one exchange, and a one-to-many exchange. The exchange object is a digital commodity that the user desires to obtain through the exchange.

At block S20, a first exchange contract of the digital commodity is generated according to the exchange conditions of the digital commodity.

In one embodiment, the first exchange contract may be automatically generated according to the received digital commodities and the exchanging conditions of the digital commodities. The first exchange contract includes a plurality of exchange information, the exchange information including at least a contract body, a digital signature, and a contract term. The contract body includes at least a digital product name, a service provided by the digital product, and an exchange method. The digital signature is a verification mode for the user to confirm the initiation of the digital commodity exchange, and may be password verification or biometric information verification. The biometric information verification may be fingerprint information verification, facial information verification, or iris information verification. The contract terms include at least contract matching conditions and commodity confirmation mechanisms.

In one embodiment, the product confirmation mechanism is a usage mode of the digital product, and includes at least a scan identification confirmation, a code input confirmation, and a password input confirmation. A one-to-one exchange in the exchange mode establishes an exchange with one user who preferentially meets the contract matching criteria. The many-to-one exchange is a multi-user bidding form, and the user who selects the most profitable among the plurality of users satisfying the contract matching condition establishes an exchange, for example, establishes an exchange with a user with a highest bid among the plurality of bidding users. A one-to-many exchange is a multi-user group purchase form, in which a user establishes an exchange with a plurality of users who satisfy the contract matching condition.

In this embodiment, the contract terms further include a plurality of keywords for representing the main content of the corresponding digital product information.

At block S30, the first exchange contract is stored to the blockchain platform of the electronic device 1 and broadcasted on each node of the blockchain.

In one embodiment, the electronic device 1 is a server cluster and includes a main server, a plurality of backbone servers, and a plurality of edge servers. The main server is configured to control the multiple backbone servers, and each backbone server is interconnected and controls multiple edge servers. The plurality of edge servers are interconnected, and each edge server can be communicatively coupled to a plurality of terminal devices 2 such that the server clusters form a blockchain platform. The edge server and the terminal device 2 are blockchain nodes, which are convenient for distributing storage resources in each node.

In one embodiment, the first exchange contract is stored in an edge server of the electronic device 1 in the form of a content delivery network (CDN) for managing an online status of the terminal device 2 node and handling various management, configuration, matching, access, and other services required for digital commodities distribution and exchange. The content delivery network relies on various edge servers to enable users to obtain exchange information, reduce network congestion, and improve user access response speed and hit rate through functional modules such as load balancing, content distribution, and scheduling of the backbone server.

At block S40, a plurality of exchange contracts is searched in the electronic device 1, and a second exchange contract is identified that matches the plurality of exchange information in the first exchange contract.

In one embodiment, the plurality of exchange contracts may be stored in the electronic device 1 before the first exchange contract is issued or after the first exchange contract is issued.

For convenience of explanation, a user A exchanges a free coffee coupon as an example. User A wants to exchange a free coffee coupon through a swap exchange and generates a first exchange contract based on the exchanging conditions provided by user A. Among them, the contract product includes a digital product name for a brand of free coffee coupons, and the service provided is a free redemption of a brand-name coffee. The exchange method is one-on-one exchange, and the exchanged commodities are book purchase discount coupons. The digital signature initiates a digital commodity exchange for the user to authenticate by fingerprint. The contract matching conditions in the contract terms include the validity use on Oct. 31, 2018, the keywords are “a cup”, “free”, and “coffee”, the discount amount is 100-300 yuan, the exchanging areas are the cities Keelung, Xinbei, and Taoyuan, the purchase discount coupon keywords are 100 yuan, 200 yuan, 300 yuan, purchase books, buy books, books, and discounts, and the product confirmation mechanism is scanning identification.

At block S40, the plurality of exchange contracts in the electronic device 1 are compared one-by-one to the first exchange contract according to the exchange conditions of the first exchange contract and in sequential order according to a broadcast date of the plurality of exchange contracts.

According to the above example, the second exchange contract may be an exchange contract in which a user B wants to exchange the book discount coupon. The digital product name included in the contract body is a bookstore 100 yuan shopping discount coupon, and the service provided is to purchase a bookstore book at a discount price of 100 yuan. The exchange method is one-to-one exchange, and the exchange product is a free coffee coupon. The digital signature initiates a digital commodity exchange for the user to authenticate by fingerprint. The contract matching conditions in the contract terms include the validity use on Dec. 31, 2018. Keywords include “100 yuan”, “book purchase”, “discount”, and the discount amount is 100 yuan. The exchanging area is the cities Keelung, Xinbei and Taoyuan. The free coffee coupon keywords include free, coffee, a cup, a bottle, and a can. The product confirmation mechanism is for scanning identification confirmation. Since the second exchange contract matches the exchange information of the first exchange contract, user A can establish an exchange with user B.

At block S50, verification information is sent to the terminal devices 2 corresponding to the first exchange contract and the second exchange contract.

In one embodiment, when the second exchange contract matching the plurality of exchange information in the first exchange contract is identified, verification information is sent to the terminal devices 2 of user A and user B to alert the users that the product exchange system described by User A and User B has been matched to the digital commodities that meet the exchange conditions. The digital signatures are verified to unlock the digital commodities to be exchanged, thereby confirming the exchange.

In block S60, whether the digital signatures returned by the two terminal devices 2 are the same as the digital signatures in the corresponding exchange contracts is determined.

In one embodiment, the digital signature is fingerprint information identification. Specifically, when the fingerprint information input by the two users through the terminal device 2 is the same as the fingerprint information in the exchange contract, it is determined that the digital signatures returned by the two terminal devices 2 are the same as the digital signatures in the corresponding exchange contracts. When the fingerprint information input by at least one user through the terminal device 2 is different from the fingerprint information in the exchange contract, it is determined that the digital signature returned by the terminal device 2 is different from the digital signature in the corresponding exchange contract, and the exchange is cancelled.

At block S70, when the digital signatures returned by the two terminal devices 2 are the same as the digital signatures in the corresponding exchange contracts, the first exchange contract and the second exchange contract are stored in the electronic device 1 in the form of a message queue.

In one embodiment, the first exchange contract and the second exchange contract are stored in an edge server of the electronic device 1 in the form of a message queue (MQ) so that multiple exchanges can be completed in sequence while simultaneously avoiding exchanging problems caused by network anomalies.

At block S80, the digital commodities in the first exchange contract and the digital commodities in the second exchange contract are respectively sent to the terminal device 2 corresponding to the second exchange contract and the terminal device 2 corresponding to the first exchange contract.

In one embodiment, the free coffee coupon of user A is sent to the terminal device 2 of user B, and the 100 yuan discount purchase ticket of user B is sent to the terminal device 2 of user A, thereby completing the exchange.

At block S90, prompt information of completion of the digital commodity exchange is sent to the terminal device 2 corresponding to the first exchange contract and the second exchange contract.

In one embodiment, the prompt information is used to alert the user of the first exchange contract and the user of the second exchange contract that the digital commodities to be exchanged have been successfully exchanged.

At block S100, the first exchange contract and the second exchange contract are deleted from the message queue in the electronic device 1.

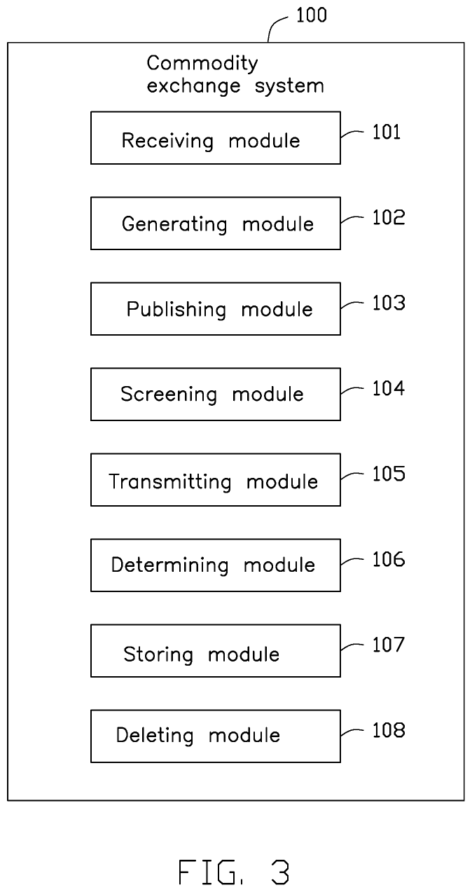

FIG. 3 is a structural diagram of an embodiment of a commodity exchange system 100.

In some embodiments, the commodity exchange system 100 operates in the electronic device 1. The electronic device 1 is in communication with a plurality of terminal devices 2 via a network. The commodity exchange system 100 can include a plurality of function modules comprised of program code segments. The program codes of each program segment in the commodity exchange system 100 may be stored in a memory of the electronic device 1 and executed by at least one processor to implement a commodity exchange system function. The function modules may include a receiving module 101, a generating module 102, a broadcasting module 103, a screening module 104, a transmitting module 105, a determining module 106, a storing module 107, and a deleting module 108. A module refers to a series of computer program segments that can be executed by at least one processor and that are capable of performing fixed functions, which are stored in a memory.

The receiving module 101 is configured to receive a digital commodity and exchange conditions of the digital commodity sent from a terminal device 2.

The generating module 102 is configured to generate a first exchange contract of the digital commodity according to the exchange conditions of the digital commodity. The first exchange contract includes at least a plurality of exchange information.

The broadcasting module 103 is configured to store the first exchange contract to a blockchain platform of the electronic device 1 and broadcast the first exchange contract on each node of the blockchain.

The screening module 104 is configured to search a plurality of exchange contracts in the electronic device 1 to identify a second exchange contract that matches the plurality of exchange information in the first exchange contract.

The transmitting module 105 is configured to send verification information to the terminal device 2 corresponding to the first exchange contract and a terminal device 2 corresponding to the second exchange contract.

The determining module 106 is configured to determine whether a digital signature returned by the two terminal devices 2 is the same as the digital signatures in the corresponding exchange contracts.

The storing module 107 is configured to store the first exchange contract and the second exchange contract in the form of a message queue when the digital signatures returned by the two terminal devices 2 is the same as the digital signatures in the corresponding exchange contracts in the electronic device 1.

The transmitting module 105 is further configured to send the digital commodity of the first exchange contract and the digital commodity of the second exchange contract to the terminal device 2 of the second exchange contract and the terminal device 2 of the first exchange contract, respectively.

The transmitting module 105 is further configured to send the prompt information of completion of the digital commodity exchange to the terminal devices 2 corresponding to the first exchange contract and the second exchange contract.

The deleting module 108 is configured to delete the first exchange contract and the second exchange contract in a message queue of the electronic device 1.

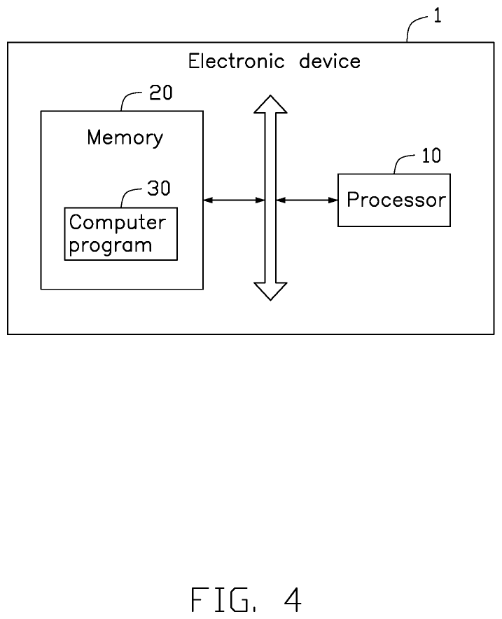

FIG. 4 is a schematic diagram of an embodiment of an electronic device 1.

The electronic device 1 includes a processor 10, a memory 20, and a computer program 30. The computer program 30 is a commodity exchange program stored in the memory 20 and executable by the processor 10. When the processor 10 executes the computer program 30, the blocks in the embodiment of the digital commodity exchange method are implemented, such as blocks S10 to S100 shown in FIG. 2. Alternatively, when the processor 10 executes the computer program 30, the functions of the modules in the above-described embodiment are implemented, such as the modules 101-108 in FIG. 3.

Illustratively, the computer program 30 can be partitioned into one or more modules/units that are stored in the memory 20 and executed by the processor 10. The one or more modules/units may be a series of computer program instruction segments capable of performing a particular function for describing the execution of the computer program 30 in the electronic device 1.

The electronic device 1 may be an electronic device such as a desktop computer, a notebook, a palmtop computer, and a cloud server. It will be understood by those skilled in the art that the schematic diagram is merely an example of the electronic device 1, and may include more or less components than those illustrated, or some components may be combined. The electronic device 1 may also include input and output devices, network access devices, buses, and the like.

The processor 30 may be a central processing unit (CPU), or may be other general-purpose processors, a digital signal processor (DSP), an application specific integrated circuit (ASIC), Field-Programmable Gate Array (FPGA) or other programmable logic device, discrete gate or transistor logic device, discrete hardware components, etc. The general purpose processor may be a microprocessor or the processor 30 may be any conventional processor or the like, and the processor 30 is a control center of the computing device 1.

The memory 20 can be used to store the computer program 40 and/or modules/units by running or executing computer programs and/or modules/units stored in the memory 20, and by calling in memory. Data within the memory 20 implements various functions of the computing device 1. The memory 20 may mainly include a storage program area and a storage data area, wherein the storage program area may store an operating system, an application required for at least one function (such as a sound playing function, an image playing function, etc.), and the like; the storage data area may be data (such as audio data, phone book data, etc.) created according to the use of the computing device 1. In addition, the memory 20 may include a high-speed random access memory, and may also include a non-volatile memory such as a hard disk, a memory, a plug-in hard disk, a smart memory card (SMC), a secure digital (SD) card, flash card, at least one disk storage device, flash device, or other volatile solid state storage device.

The modules/units integrated by the computing device 1 can be stored in a computer readable storage medium if implemented in the form of a software functional unit and sold or used as a stand-alone product. Based on such understanding, all or part of the processes in the above-described embodiments are implemented and may also be implemented by a computer program to instruct related hardware. The computer program may be stored in a computer readable storage medium. The blocks of the various method embodiments described above may be implemented by a computer program when executed by a processor. The computer program includes computer program code, which may be in the form of source code, object code form, executable file or some intermediate form. The computer readable medium may include any entity or device capable of carrying the computer program code, a recording medium, a USB flash drive, a removable hard disk, a magnetic disk, an optical disk, a computer memory, a read-only memory (ROM), a random access memory (RAM, Random Access Memory), electrical carrier signals, telecommunications signals, and software distribution media. It should be noted that the content contained in the computer readable medium may be appropriately increased or decreased according to the requirements of legislation and patent practice in a jurisdiction, for example, in some jurisdictions, according to legislation and patent practice, computer readable media does not include electrical carrier signals and telecommunication signals.

In the several embodiments described above, it should be understood that the disclosed computer apparatus and method may be implemented in other manners. For example, the computing device embodiments described above are merely illustrative. For example, the division of the unit is only a logical function division, and the actual implementation may have another division manner.

In addition, each functional unit in each embodiment may be integrated in the same processing unit, each unit may exist physically separately, or two or more units may be integrated in the same unit. The above integrated unit can be implemented in the form of hardware or in the form of hardware plus software function modules.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A digital commodity exchange method implemented in an electronic device, the method comprising:
receiving a digital commodity and exchanging conditions of the digital commodity transmitted by a user terminal device;
generating a first exchange contract of the digital commodity according to a exchange condition of the digital commodity, the first exchange contract comprising a plurality of exchange information;
storing the first exchange contract to a blockchain platform of the electronic device and broadcasting the first exchange contract on each node of the blockchain;
searching a plurality of exchange contracts in the electronic device and identifying a second exchange contract that matches the plurality of exchange information in the first exchange contract;
storing the first exchange contract and the second exchange contract in the form of a message queue in the electronic device; and
transmitting the digital commodity of the first exchange contract and the digital commodity of the second exchange contract to the terminal device of the second exchange contract and the terminal device of the first exchange contract, respectively.

2. The method of claim 1 further comprising:
transmitting a prompt of digital exchange completion of the first exchange contract and the second exchange contract to the corresponding terminal devices.

3. The method of claim 2 further comprising:
deleting the first exchange contract and the second exchange contract from the message queue in the electronic device when the prompt of digital exchange completion is successfully transmitted.

4. The method of claim 1 further comprising:
storing the plurality of exchange contracts in the electronic device in the form of a content delivery network.

5. The method of claim 1, wherein:
the exchange information comprises at least a contract body, a digital signature, and contract terms;
the contract body comprises at least a digital product name, a service provided by the digital product, and an exchange method; and
the contract terms comprise at least a contract matching condition and a commodity confirmation mechanism.

6. The method of claim 5 further comprising:
sending a verification message to the terminal device of the first exchange contract and the terminal device of the second exchange contract when the second exchange contract matching the plurality of exchange information in the first exchange contract is identified;
determining whether each digital signature returned by the two terminal devices is the same as the digital signature in the corresponding exchange contracts; and
storing the first exchange contract and the second exchange contract in the electronic device in the form of a message queue when each of the digital signatures returned by the two terminal devices is the same as the digital signature in the corresponding exchange contracts.

7. The method of claim 5, wherein:
a method of exchange comprises at least a one-to-one exchange, a many-to-one exchange, and a one-to-many exchange; and
a mechanism of commodity confirmation comprises at least a scan identification confirmation, a code input confirmation, and a password input confirmation.

8. An electronic device comprising:
a processor; and
a memory storing a plurality of instructions, which when executed by the processor, cause the processor to:
receive digital a commodity and exchanging conditions of the digital commodity transmitted by a user terminal device;
generate a first exchange contract of the digital commodity according to an exchange condition of the digital commodity, the first exchange contract comprising a plurality of exchange information;
store the first exchange contract to a blockchain platform of the electronic device and broadcast the first exchange contract on each node of the blockchain;
search a plurality of exchange contracts in the electronic device and identify a second exchange contract that matches the plurality of exchange information in the first exchange contract;
store the first exchange contract and the second exchange contract in the form of a message queue in the electronic device; and
transmit the digital commodity of the first exchange contract and the digital commodity of the second exchange contract to the terminal device of the second exchange contract and the terminal device of the first exchange contract, respectively.

9. The electronic device of claim 8, wherein the processor is further configured to:
transmit a prompt of digital exchange completion of the first exchange contract and the second exchange contract to the corresponding terminal devices.

10. The electronic device of claim 8, wherein the processor is further configured to:
delete the first exchange contract and the second exchange contract from the message queue in the electronic device.

11. The electronic device of claim 8, wherein the processor is further configured to:
store the plurality of exchange contracts in the electronic device in the form of a content delivery network.

12. The electronic device of claim 8, wherein:
the exchange information comprises at least a contract body, a digital signature, and contract terms;
the contract body comprises at least a digital product name, a service provided by the digital product, and an exchange method; and
the contract terms comprise at least a contract matching condition and a commodity confirmation mechanism.

13. The electronic device of claim 12, wherein the processor is further configured to:
send a verification message to the terminal device of the first exchange contract and the terminal device of the second exchange contract when the second exchange contract matching the plurality of exchange information in the first exchange contract is identified;
determine whether a digital signature returned by the two terminal devices is the same as the digital signature in the corresponding exchange contracts; and
store the first exchange contract and the second exchange contract in the electronic device in the form of a message queue when the digital signature returned by the two terminal devices is the same as the digital signature in the corresponding exchange contracts.

14. The electronic device of claim 12, wherein:
a method of exchange comprises at least a one-to-one exchange, a many-to-one exchange, and a one-to-many exchange; and
a mechanism of commodity confirmation comprises at least a scan identification confirmation, a code input confirmation, and a password input confirmation.

15. A non-transitory storage medium having stored thereon instructions that, when executed by at least one processor of an electronic device, causes the at least one processor to execute instructions of a digital commodity exchange method, the method comprising:
receiving a digital commodity and exchanging conditions of the digital commodity transmitted by a user terminal device;
generating a first exchange contract of the digital commodity according to an exchange condition of the digital commodity, the first exchange contract comprising a plurality of exchange information;
storing the first exchange contract to a blockchain platform of the electronic device and broadcasting the first exchange contract on each node of the blockchain;
searching a plurality of exchange contracts in the electronic device and identifying a second exchange contract that matches the plurality of exchange information in the first exchange contract;
storing the first exchange contract and the second exchange contract in the form of a message queue in the electronic device; and
transmitting the digital commodity of the first exchange contract and the digital commodity of the second exchange contract to the terminal device of the second exchange contract and the terminal device of the first exchange contract, respectively.

16. The non-transitory storage medium of claim 15, wherein the method further comprises:
transmitting a prompt of digital exchange completion of the first exchange contract and the second exchange contract to the corresponding terminal devices.

17. The non-transitory storage medium of claim 15, wherein the method further comprises:
deleting the first exchange contract and the second exchange contract from the message queue in the electronic device.

18. The non-transitory storage medium of claim 15, wherein the method further comprises:
storing the plurality of exchange contracts in the electronic device in the form of a content delivery network.

19. The non-transitory storage medium of claim 15, wherein:
the exchange information comprises at least a contract body, a digital signature, and contract terms;
the contract body comprises at least a digital product name, a service provided by the digital product, and an exchange method;
the contract terms comprise at least a contract matching condition and a commodity confirmation mechanism;
a method of exchange comprises at least a one-to-one exchange, a many-to-one exchange, and a one-to-many exchange; and
a mechanism of commodity confirmation comprises at least a scan identification confirmation, a code input confirmation, and a password input confirmation.

20. The non-transitory storage medium of claim 19, wherein the method further comprises:
sending a verification message to the terminal device of the first exchange contract and the terminal device of the second exchange contract when the second exchange contract matching the plurality of exchange information in the first exchange contract is identified;
determining whether a digital signature returned by the two terminal devices is the same as the digital signature in the corresponding exchange contracts; and
storing the first exchange contract and the second exchange contract in the electronic device in the form of a message queue when the digital signature returned by the two terminal devices is the same as the digital signature in the corresponding exchange contracts.
